(19) United States
(12) Patent Application Publication
(10) Pub. No.: US 2005/0266389 A1
(43) Pub. Date: Dec. 1, 2005

(54) Personalizable product packages

(75) Inventors: Michael A. Singleton, Warwick, RI (US); John J. Chapski, East Greenwich, RI (US)

Correspondence Address: PILLSBURY WINTHROP SHAW PITTMAN, LLP, P.O. BOX 10500, MCLEAN, VA, 22102, US

(73) Assignee: Stanley Fastening Systems, L.P., East Greenwich, RI (US)

(21) Appl. No.: 11/123,220

(22) Filed: May 6, 2005

Related U.S. Application Data
(60) Provisional application No. 60/568,701, filed on May 7, 2004.

(51) Int. Cl. G09B 19/00

(52) U.S. Cl. 434/365

(57) ABSTRACT

A personalized school or office tool package is disclosed. The personalizable school or office tool package includes packaging, and a school or office tool that is carried by the packaging. The school or office tool has an area that is suitable to receive a personalizing member. The package also includes a plurality of members that have personalizing indicia thereon. The members are carried by the packaging and are self-adhering on one side and have the personalizing indicia on an opposite side so that a user can select from the plurality of members and attach a chosen member to the school or office tool, with the self-adhering surface in contact with the area suitable to receive the member, to personalize the school or office tool.

### CROSS-REFERENCE TO RELATED APPLICATIONS

The present application claims the benefit of priority from U.S. Provisional Patent Application Ser. No. 60/568,701, entitled “PERSONALIZABLE PRODUCT PACKAGES,” filed May 7, 2004, the entire content of which is incorporated herein by reference.

### BACKGROUND OF THE INVENTION

1. Field of the Invention

The present invention relates to packages of products, and more particularly to packages of school or office tools that can be personalized.

2. Description of Related Art

School and office products that are used as tools to perform tasks on fungible items such as paper and pencils are offered in a wide variety of shapes and sizes. For example, staplers can range from small hand-held staplers to large power-operated staplers that are attached to copier machines. Hole punches can vary from a single hand-held hole punch to desktop hole punches that can simultaneously punch a plurality of holes at a time. Pencil sharpeners can range from small plastic hand-held sharpeners in which the sharpener can be manually rotated about a pencil to desktop power-operated pencil sharpeners in which a pencil is inserted and automatically sharpened a predetermined amount. Flashlights can range from small penlights to large flashlights with handles and even multiple lights.

A market segment exists for small, portable school or office tools that can be carried in a briefcase or a school bag. Because it is relatively easy to lose such items, a need has emerged to be able to attach such items to an article, such as a belt or a bag, yet still allow the tool itself to be accessible. An example of a small, portable office tool that can be hung around a person's neck is disclosed in U.S. Pat. No. 6,601,747, hereby incorporated by reference in its entirety.

In environments such as schools, many children carry around the same school tools, thereby contributing to the problem of losing the tools because the tools can be mixed with other children's tools and the children cannot identify which tool belongs to him or her. A need exists to allow for such school or office tools to be personalized so that each owner can more easily identify his or her tool, and also decorate the tool to his or her own personal liking.

### BRIEF SUMMARY OF THE INVENTION

It is one aspect of embodiments of the present invention to provide a package that includes a product that can be personalized to the user's own personal liking.

It is another aspect of embodiments of the present invention to provide a package that includes a school or office tool that can be personalized to the user's own personal liking.

In at least one embodiment, a personalizable school or office tool package is provided. The personalizable school or office tool package includes packaging, and a school or office tool that is carried by the packaging. The school or office tool has an area that is suitable to receive a personalizing member. The package also includes a plurality of members that have personalizing indicia thereon. The members are also carried by the packaging. The members are self-adhering on one side and have the personalizing indicia on an opposite side so that a user can select from the plurality of members and attach a chosen member to the school or office tool, with the self-adhering surface in contact with the area suitable to receive the member, to personalize the school or office tool.

It is a further aspect of embodiments of the present invention to provide a package that includes a plurality of school or office tools that can be personalized to the user's own personal liking.

In at least one embodiment, a personalizable school or office tool package is provided. The package includes packaging, and a plurality of school or office tools that are carried by the packaging. Each school or office tool has an area suitable to receive a personalizing member. The package also includes a multiplicity of members that have personalizing indicia thereon. The members are also carried by the packaging. The members are self-adhering on one side and have the personalizing indicia on an opposite side so that a user can select from the multiplicity of members and attach a chosen member to each of the school or office tools, with the self-adhering surface in contact with the area suitable to receive the member, to personalize the school or office tool. The multiplicity of members are greater in number than the plurality of school or office tools.

These and other aspects of the invention will become apparent from the following detailed description when taken in conjunction with the accompanying drawings, which are part of this disclosure and which illustrate, by way of example, the principles of this invention.

### BRIEF DESCRIPTION OF THE DRAWINGS

Features of the invention are shown in the drawings, in which like reference numerals designate like elements. The drawings form part of this original disclosure, in which:

FIG. 1 is a top view of one embodiment of a personalizable school or office tool package of the present invention;

FIG. 2 is a perspective view of a stapler that may be included in at least one embodiment of the present invention;

FIG. 3 is a perspective view of a hole punch that may be included in at least one embodiment of the present invention;

FIG. 4 is a perspective view of a pencil sharpener that may be included in at least one embodiment of the present invention;

FIG. 5 is a perspective view of a flashlight that may be included in at least one embodiment of the present invention; and

FIG. 6 is a top view of another embodiment of a personalizable school or office tool package of the present invention.

### DETAILED DESCRIPTION OF THE INVENTION

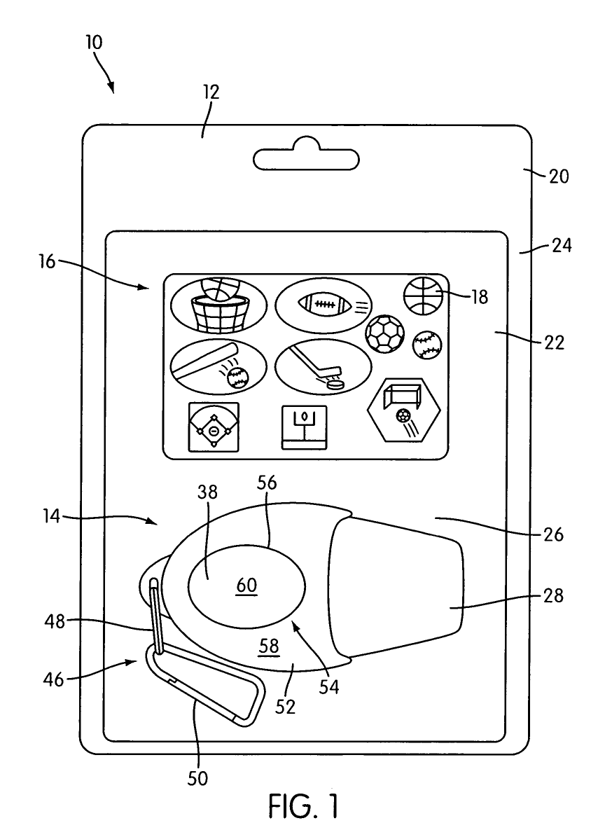

FIG. 1 shows a package 10 of one embodiment of the present invention. The package 10 includes packaging 12, a product 14, and a plurality of members 16 having personalizing indicia 18 thereon.

The packaging 12 may include a wood pulp based product 20, such as paper, cardboard, or any other type of wood pulp based product that is typically used in packaging. The packaging 12 may also include plastic 22, such as polyvinyl chloride (“PVC”), polyethylene terephthalate (“PET”), polyolefin, or any other type of plastic that is typically used in packaging. The plastic 22 may be formed so that it at least partially surrounds the product 14 so that a purchaser can view the product as it is displayed in a store. As shown, the packaging 12 may include both a cardboard backing 24 and a plastic bubble pack 26 that is attached to the cardboard backing 24. The plastic bubble pack 26 may surround the cardboard backing 24, or may be sized to cover the product 14 and be attached to the cardboard backing 24 by known methods. It is also contemplated that the packaging 12 may be completely constructed from the wood pulp based product 20, such as a cardboard box, or may be completely constructed from the plastic 22. All types of packaging are contemplated and the examples described herein should not be construed to be limiting in any way.

In the embodiments shown, the product 14 includes a school or office tool 28, although it is understood that the product 14 may be any product that is suitable for personalization. The school or office tool 28 is preferably a stapler 30, a hole punch 32, or a pencil sharper 34, as these types of school or office tools are often carried in or by portable articles, such as school bags, purses, briefcases, etc. The school or office tool 28 is carried by the packaging 12 in such a way that the product 14 may be properly displayed in a store prior to purchase. After the package 10 is purchased, the school or office tool 28 may be removed from the packaging 12 and the packaging 12 may then be recycled or otherwise disposed of.

Also packaged with the school or office tool 28 are the plurality of members 16. The school or office tool 28 includes an area 38 that is suitable to receive at least one of the plurality of members 16. The plurality of members 16 each include personalizing indicia 40 on one side. The members 16 are also carried by the packaging 12. Each member 16 also includes a self-adhering surface 42 on an opposite side of the side that includes the personalizing indicia 40. This way, a user can select from the plurality of members 16 and attach a chosen member 44 to the school or office tool 28 with the self-adhering surface 42 in contact with the area 38 that is suitable to receive the member 16 to personalize the school or office tool 28.

As shown in FIG. 1, the package 10 may further include an attachment structure 46 that is operatively connected to the school or office tool 28. The attachment structure 46 is constructed and arranged to attach the school or office tool 28 to the article. As shown, the attachment structure 46 may include a ring 48 and a closable hook 50. It is understood that although both the ring 48 and the hook 50 are shown, the ring 48 or the hook 50 may be used alone. It is also contemplated that the attachment structure 46 may be a string or any other type of attachment structure known in the art.

The package 10 may further include a cap 52 that is constructed and arranged to be releasably secured to the school or office tool 28. The cap 52 includes a portion of a locking structure 54 that is constructed and arranged to be releasably secured to a complementary portion that is disposed on the school or office tool 28. In the embodiment shown, the cap 52 includes an opening 56 through a side wall 58, and the school or office tool 28 includes a raised portion 60 that is constructed to be received by the opening 56 such that when the school or office tool 28 is received by the cap 52, the raised portion 60 is received by the opening 56, thereby securing the school or office tool 28 to the cap 52. To remove the school or office tool 28 from the cap 52, the raised portion 60 may be moved out of the opening 56 so that the school or office tool 28 is now free to be separated from the cap 52.

As shown in the figures, the size and shape of each of the school or office tools 28 illustrated are about the same so the each school or office tool 28 may be releasably secured to each cap 52. This way, one cap 52 design will fit each of the school or office tools 28, thereby enabling the user to interchange the caps 52.

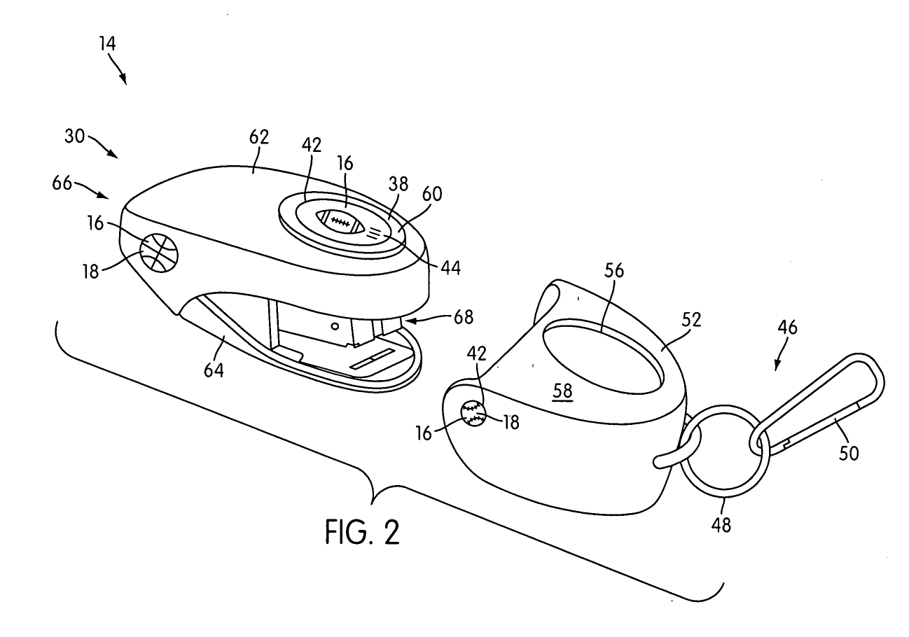

The stapler 30, shown in greater detail in FIG. 2, includes a top 62 and a bottom 64 that is hingedly connected to the top 62 at one end 66. A stapling mechanism 68 is disposed between the top 62 and the bottom 64. The stapling mechanism 68 is constructed and arranged to store a plurality of staples and to drive one staple at a time into a substrate, such as paper. Details of the stapling mechanism 68 will not be described herein because such mechanisms are well known in the art. The raised portion 60 is disposed on the stapler 30 at the top 62 such that when the bottom 64 of the stapler 30 is placed on a surface, such as a table, the raised portion 60 extends upward and away from the surface. It is also contemplated that the raised portion 60 may extend from any part of the stapler 30, but in the preferred embodiment, the raised portion 60 extends from the top 62. The hinged movement of the top 62 relative to the bottom 64 allows the stapler 30 to be squeezed and inserted into the cap 52. Upon release, the raised portion 60 is inserted into the opening 56 in the side wall 58 of the cap 52, thereby securing the stapler 30 to the cap 52. The stapler 30 may be released from the cap 52 by squeezing the top 62 and bottom 64 toward one another, and pulling the stapler 30 away from the cap 52.

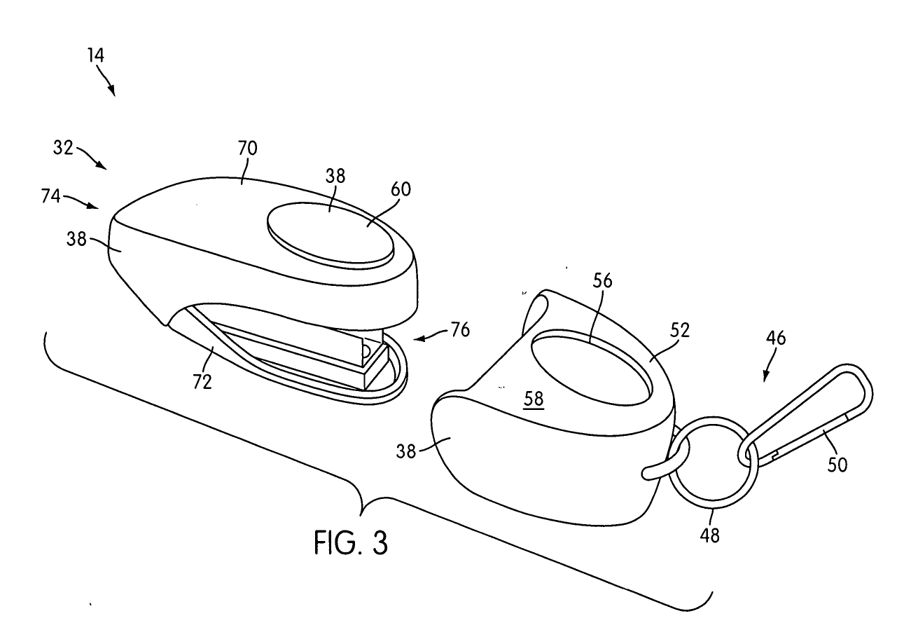

The hole punch 32 is shown in greater detail in FIG. 3. The hole punch 32 includes a top 70 and a bottom 72 that is hingedly connected to the top 70 at one end 74. A hole punch mechanism 76 is constructed and arranged to punch a hole of a predetermined shape through a substrate, such as paper. Details of the hole punch mechanism 76 will not be described herein because such mechanisms are well known in the art. The raised portion 60 is disposed on the hole punch 32 at the top 70 such that when the bottom 72 of the hole punch 32 is placed on a surface, such as a table, the raised portion 60 extends upward and away from the surface. It is also contemplated that the raised portion 60 may extend from any part of the hole punch 32, but in the preferred embodiment, the raised portion 60 extends from the top 62. The hinged movement of the top 70 relative to the bottom 72 allows the hole punch 32 to be squeezed and inserted into the cap 52. Upon release, the raised portion 60 is inserted into the opening 56 in the side wall 58 of the cap 52, thereby securing the hole punch 32 to the cap 52. The hole punch 32 may be released from the cap 52 by squeezing the top 70 and bottom 72 toward one another, and pulling the hole punch 32 away from the cap 52.

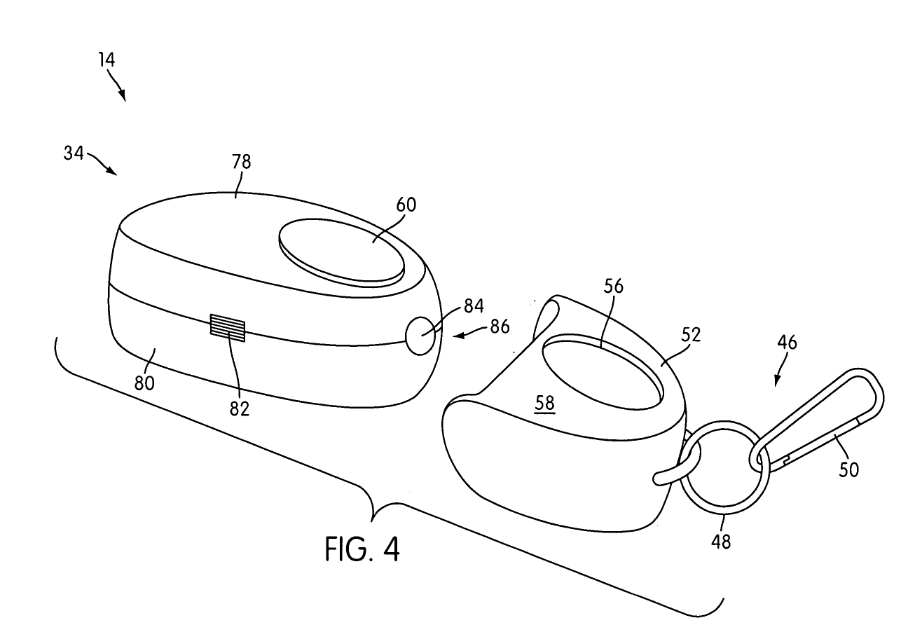

The pencil sharpener 34 is shown in greater detail in FIG. 4. The pencil sharpener 34 includes a top portion 78 that is releasably secured to a bottom portion 80 by a locking structure 82. The locking structure 82 of the pencil sharpener 34 may be of any design that allows the top portion 78 and the bottom portion 80 to remain securely attached to one another during normal use, yet be separable when shavings need to be emptied from the pencil sharpener 34. An opening 84 is disposed at one end 86 of the pencil sharpener 34 and is sized to receive a pencil. The pencil sharpener 34 also includes a blade (not shown) that is disposed within a space that is created by the top portion 78 and the bottom portion 80 in such an orientation so as to properly shave the pencil when the pencil is inserted into the opening 84 and rotated relative to the pencil sharpener 34. To assist in the attachment and removal of the pencil sharpener 34 to the cap 52, the raised portion 60 is movably mounted to the top portion 78. It is also contemplated that the raised portion 60 may extend from any part of the pencil sharpener 34, but in the preferred embodiment, the raised portion 60 extends from the top 62. Preferably, a biasing member (not shown) is disposed between the top portion 78 and the raised portion 60 so as to bias the raised potion 60 upward and away from the top portion 78. The raised portion 60 may be pressed toward the top portion 78 against the bias of the biasing member so that the end 86 of the pencil sharpener 34 that includes the opening 84 may be inserted into the cap 52. Releasing the raised portion 60 allows the raised portion 60 to be received by the opening 56 in the side wall 58 of the cap 52, thereby securing the pencil sharpener 34 to the cap 52. The pencil sharpener 34 may be released from the cap 52 by pressing the raised portion 60 against the bias of the biasing member while pulling the pencil sharpener 34 away from the cap 52.

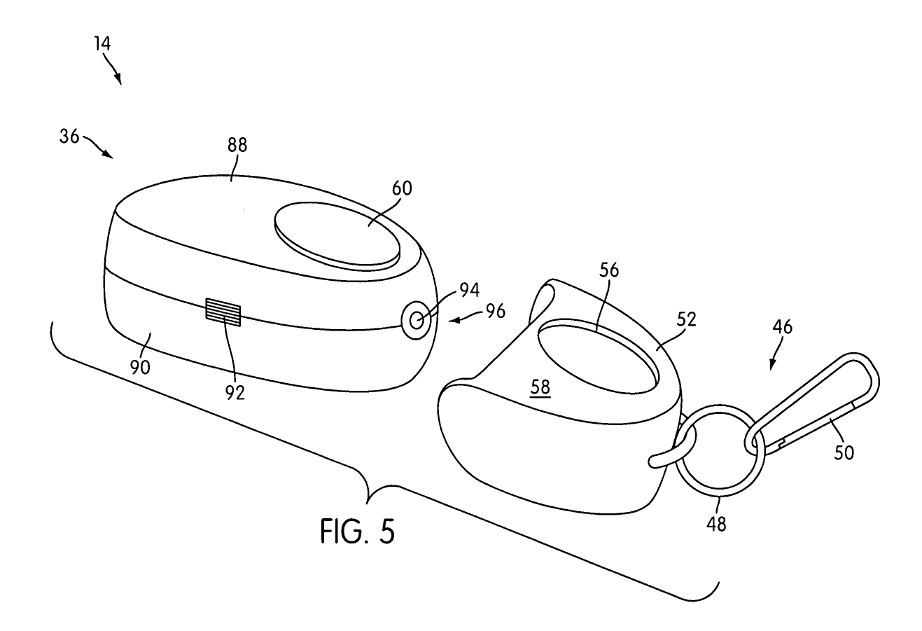

The flashlight 36, shown in greater detail in FIG. 5, similar to the pencil sharpener 34, the flashlight 36 includes a top portion 88 that is releasably secured to a bottom portion 90 by a locking structure 92. The locking structure 92 of the flashlight 36 may be of any design that allows the top portion 88 and the bottom portion 90 to remain securely attached to one another during normal use, yet be separable when a battery (not shown) or bulb 94 need to be replaced. To assist in the attachment and removal of the flashlight 36 to the cap 52, the raised portion 60 is movably mounted to the top portion 88. It is also contemplated that the raised portion 60 may extend from any part of the flashlight 36, but in the preferred embodiment, the raised portion 60 extends from the top portion 88. Preferably, a biasing member (not shown) is disposed between the top portion 88 and the raised portion 60 so as to bias the raised potion 60 upward and away from the top portion 88. The raised portion 60 may be pressed toward the top portion 88 against the bias of the biasing member so that the end 96 of the flashlight 36 that includes the bulb 94 may be inserted into the cap 52. Releasing the raised portion 60 allows the raised portion 60 to be received by the opening 56 in the side wall 58 of the cap 52, thereby securing the flashlight 36 to the cap 52. The flashlight 36 may be released from the cap 52 by pressing the raised portion 60 against the bias of the biasing member while pulling the flashlight 36 away from the cap 52. The raised portion 60 may also be operatively connected to a switch (not shown) that allows the flashlight 36 to be turned on and off. Preferably, the switch is arranged such that pressing the raised portion 60 will illuminate the bulb 94 and releasing the raised portion 60 will cause the bulb 94 to turn off. This way, when the flashlight 36 is secured to the cap 52, the flashlight 36 will be off.

It is contemplated that the locking structure 54 that releasably secures the school or office tool 28 to the cap 52 may include any type of structure that allows the school or office tool 28 to be releasably secured to the cap 52. For example, the locking structure 54 may include a pair of magnets that are arranged to be attracted to one another, whereby one magnet is connected to the cap 52 and the other magnet is connected to the school or office tool 28. Other press-fit arrangements are also contemplated and are considered to be within the scope of embodiments of the invention. The structures illustrated should not be considered to be limiting in any way.

As shown in FIG. 1, the attachment structure 46 may be connected to the cap 52 so that the cap 52 is attached to the article. In this embodiment, the cap 52 is able to remain attached to the article as the school or office tool 28 is removed from the cap 52. The school or office tool 28 can then be reconnected to the cap 52 when the user is done using the school or office tool 28, in a manner described above.

As discuss above, the plurality of members 16 include personalizing indicia 18 so that the user may select at least one of the plurality of members 16 to attach to the school or office tool 28 in a personalizing way. By packaging a variety of members 16, the user has ample choices to personalize the school or office tool 28. Preferably, the personalizing indicia 18 that are included in the package 10 relate to a theme or common subject matter. For example, the theme may be sports and the personalizing indicia 18 my include a soccer ball, a basketball, a baseball, a football, etc., as shown in FIG. 1. Alternatively, the theme may by insects and the personalizing indicia 18 may include different species of butterflies, lady bugs, etc., as shown in FIG. 5. It is also contemplated that the theme may include animals (dogs, cats, horses, zoo animals, etc.), cartoon characters, transportation (planes, trains, automobiles, motorcycles, etc.), sports teams, etc. It is understood that these examples should not be construed in any way as being limiting and are merely presented as examples of what is meant by “theme.” The personalizing indicia 18 may also include alphabetical letters, either in the form of individual letters or names.

In the embodiment shown in FIG. 1, at least one of the members 16 is sized so that it covers the area 38 on the raised portion 60 of the school or office tool 28 that extends into the opening 56 in the side wall 58 of the cap 52. This way, the personalizing indicia 18 may be exposed even when the school or office tool 28 is attached to the cap 52. Of course, the members 16 may be attached to the school or office tool 28 or the cap 52 in any area 38 that is large enough to receive the members 16, as shown in FIG. 1.

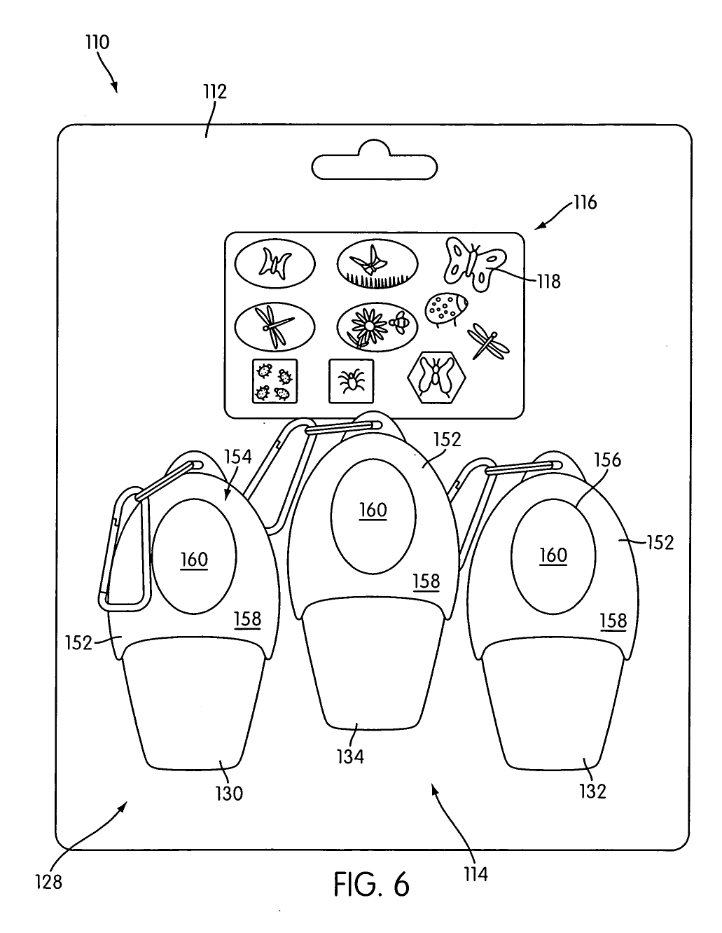

FIG. 6 shows another embodiment of the present invention. In this embodiment, a package 110 includes packaging 112 that is sized to accommodate a plurality of products 114, and a multiplicity of members 116 having personalizing indicia 118 thereon.

In this embodiment, the plurality of products 114 include a plurality of school or office tools 128, although it is understood that the plurality of products 114 may be any set of related products that are suitable for personalization. The plurality of school or office tools 128 are carried by the packaging 112. Preferably, the plurality of school or office tools 128 includes a stapler 130, a hole punch 132, and a pencil sharpener 134. It is also contemplated that the plurality of school or office tools 128 may also include a flashlight (not shown). The stapler 130, the hole punch 132, the pencil sharpener 134, and the flashlight are the same as the stapler 30, hole punch 32, pencil sharpener 34, and flashlight 36, respectively, of the previous embodiment, and therefore will not be described in detail.

In this embodiment, the package 110 also includes a plurality of caps 152, each of which is constructed and arranged to be releasably secured to each of the school or office tools 128. This way, any combination of caps 152 and school or office tools 128 may be made. Preferably, the caps 152 and school or office tool 128 include complementary colors so that the user may personalize the combinations of the caps 152 and the school or office tools 128.

The multiplicity of members 116 include personalizing indicia 118 so that the user may select at least one of the multiplicity of members 116 to attach to each of the plurality of school or office tools 128. The members 116 are carried by the packaging 112. The multiplicity of members 116 provides a variety of members 116, thereby giving the user ample choices to personal each of the school or office tools 128. In case the user desires to personalize each of the school or office tools 128 in the same manner, members 116 containing the same personalizing indicia 118 may be included. For example, if three school or office tools 128 are included in the package 110, three plurality of members 16, all related to the same theme, as described above, are also included. Alternatively, three plurality of members 16, each related to a different theme, may be included in the package 110 that includes three school or office tools 128.

The same details of the various school or office tools 28 that were described above apply to the school or office tools 128 of this embodiment. For example, each of the school or office tools 128 includes a raised portion 160 that is part of a locking structure 154 that also includes an opening 156 in a side wall 158 of the cap 160. The locking structure 154 operates in the same manner as the locking structure 54 of the previously described embodiment.

While preferred embodiments of the invention have been shown and described, it is evident that variations and modifications are possible that are within the spirit and scope of the preferred embodiments described herein. The disclosed embodiments have been provided solely to illustrate the principles of the invention and should not be considered limiting in any way.

1. A personalizable school or office tool package comprising:
packaging;
a school or office tool carried by the packaging, the school or office tool having an area suitable to receive a personalizing member; and
a plurality of members having personalizing indicia thereon, the members being carried by the packaging, and being self-adhering on one side and having the personalizing indicia on an opposite side so that a user can select from the plurality of members and attach a chosen member to the school or office tool with the self-adhering surface in contact with the area suitable to receive the member to personalize the school or office tool.

2. The package of claim 1, wherein the school or office tool is selected from the group consisting of: a stapler, a hole punch, a pencil sharpener, and a flashlight.

3. The package of claim 1, further comprising an attachment structure operatively connected to the school or office tool for attaching the school or office tool to an article.

4. The package of claim 1, further comprising a cap constructed and arranged to be releasably secured to the school or office tool.

5. The package of claim 4, further comprising an attachment structure connected to the cap for attaching the cap to an article.

6. The package of claim 5, further comprising a releasable locking structure constructed and arranged to temporarily lock the school or office tool to the cap so that the tool may be attached to the article when not in use.

7. The package of claim 5, wherein the attachment structure comprises a ring.

8. The package of claim 5, wherein the attachment structure comprises a closable hook.

9. The package of claim 1, wherein the personalizing indicia relate to a theme.

10. The package of claim 9, wherein the theme is selected from the group consisting of: sports, animals, insects, cartoon characters, and transportation.

11. The package of claim 1, wherein the personalizing indicia comprises alphabetical letters.

12. The package of claim 1, wherein the area suitable to receive a personalizing member has a shape corresponding to the shape of said members.

13. The package of claim 1, wherein the packaging comprises a pulp-based product.

14. The package of claim 1, wherein the packaging comprises plastic.

15. A personalizable school or office tool package comprising:
packaging;
a plurality of school or office tools carried by the packaging, each school or office tool having an area suitable to receive a personalizing member; and
a multiplicity of members having personalizing indicia thereon, the members being carried by the packaging, and being self-adhering on one side and having the personalizing indicia on an opposite side so that a user can select from the multiplicity of members and attach a chosen member to each of the school or office tools with the self-adhering surface in contact with the area suitable to receive the member to personalize each school or office tool, the multiplicity of members being greater in number than the plurality of school or office tools.

16. The package of claim 15, wherein each of the plurality of school or office tools is selected from the group consisting of a stapler, a hole punch, a pencil sharpener, and a flashlight.

17. The package of claim 15, further comprising plurality of attachment structures, each attachment structure being operatively connected to each school or office tool for attaching the school or office tool to an article.

18. The package of claim 15, further comprising a plurality of interchangeable caps, each cap being constructed and arranged to be releasably secured to each school or office tool.

19. The package of claim 18, further comprising a plurality of attachment structures, each attachment structure being connected to each cap for attaching the cap to an article.

20. The package of claim 19, further comprising a plurality of releasable locking structures, each locking structure being constructed and arranged to temporarily lock each school or office tool to each cap so that the tool may be attached to the article when not in use.

21. The package of claim 19, wherein each attachment structure comprises a ring.

22. The package of claim 19, wherein each attachment structure comprises a closable hook.

23. The package of claim 15, wherein the personalizing indicia relate to a theme.

24. The package of claim 23, wherein the theme is selected from the group consisting of: sports, animals, insects, cartoon characters, and transportation.

25. The package of claim 23, wherein the personalizing indicia comprises alphabetical letters.

26. The package of claim 15, wherein the area suitable to receive a personalizing member has a shape corresponding to the shape of said members.

27. The package of claim 15, wherein the packaging comprises a wood pulp-based product.

28. The package of claim 15, wherein the packaging comprises plastic.
